(19) United States
(12) Patent Application Publication
(10) Pub. No.: US 2012/0145787 A1
(43) Pub. Date: Jun. 14, 2012

(54) DISPLAY DEVICE

(75) Inventor: TAI-SENG LIN, TAIPEI CITY (TW)

(73) Assignee: FLYTECH TECHNOLOGY CO., LTD., TAIPEI CITY (TW)

(21) Appl. No.: 12/964,906

(22) Filed: Dec. 10, 2010

(51) Int. Cl. G06K 7/01

(52) U.S. Cl. 235/439

(57) ABSTRACT

A display device is provided. The display device comprises a screen body and two swipe card readers. The screen body has a front surface and a rear surface and comprises at least one display screen unit. The two swipe card readers are separately disposed on the front and the rear surface of the screen body and electrically connected to the at least one display screen unit.

### BACKGROUND OF THE INVENTION

1. Field of the Invention

The present invention relates to a display device; in particular, the invention relates to a display device having a pair of integrated swipe card readers.

2. Description of the Related Art

Liquid crystal displays (LCD) have the advantages of being light-weight, low profile, energy efficient, and radiation hazard-free. Thus, liquid crystal displays have gradually become the main stream choice of display. On the other hand, smart cards, such as credit cards, debit cards rechargeable cards, and various electronic tickets, have been widely used for daily transactions. To complete electronic transactions using smart cards, card readers are often used. One example of such card reader is the swipe card reader in convenient stores. Moreover, a swipe card reader is often attached to a LCD display device. This arrangement not only saves space but also provides convenient accessibility to the swipe card reader.

However, as the card reader is only disposed on one side of the display device (generally on the cashier side), the customers have to hand over the credit card, debit card or rechargeable card to the cashier. Inevitably, the cashier/customers may forget to give back/take back their card. Further, it may cost the customers more time to wait the cashier to swipe the cards during check-out.

Accordingly, a display device with two card readers disposed on two opposite sides is provided. Thus, either the cashier or the customer may execute the card swiping action. Thus, the efficiency of the transaction may be further improved because of the increased convenience and accessibility to the card readers.

In view of this, it is important to provide a touch panel with a flat surface. Based on research, the inventor proposes the present invention to address the above issues.

### SUMMARY OF THE INVENTION

A display device is provided. The display device comprises a screen body and two swipe card readers. The screen body having a front surface and a rear surface. The screen body comprises at least one display screen unit. The two swipe card readers are disposed on the front surface and the rear surface and electrically connected to the at least one display screen unit.

The instant disclosure has following benefits: due to two swipe card readers are disposed on the two sides of the display device so that a user could swipe their wisdom card easily by a swipe card reader on a closer side.

In order to further appreciate the characteristics and technical contents of the present invention, references are hereunder made to the detailed descriptions and appended drawings in connection with the present invention. However, the appended drawings are merely shown for exemplary purposes, rather than being used to restrict the scope of the present invention.

### BRIEF DESCRIPTION OF THE DRAWINGS

FIG. 1 is a schematic perspective view of the display device of the first embodiment of the present invention;

FIG. 2 is a schematic perspective view of the display device of the first embodiment of the present invention;

FIG. 3 is a schematic perspective view of the display device of the second embodiment of the present invention;

FIG. 4 is a schematic perspective view of the display device of the second embodiment of the present invention; and

FIG. 5 is a schematic perspective view of the display device of the second embodiment of the present invention.

### DETAILED DESCRIPTION OF THE PREFERRED EMBODIMENT

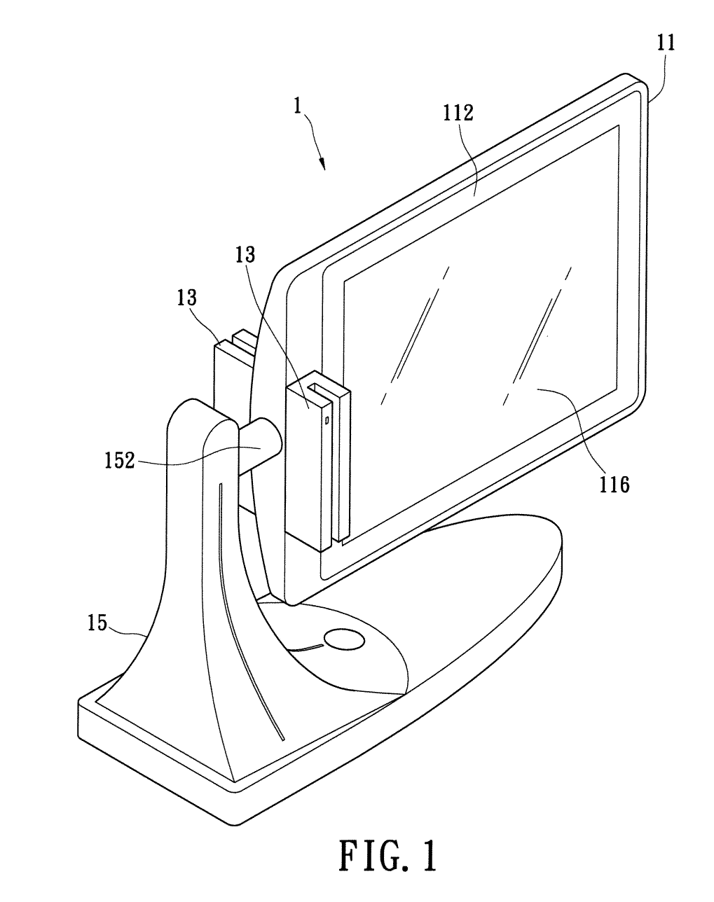

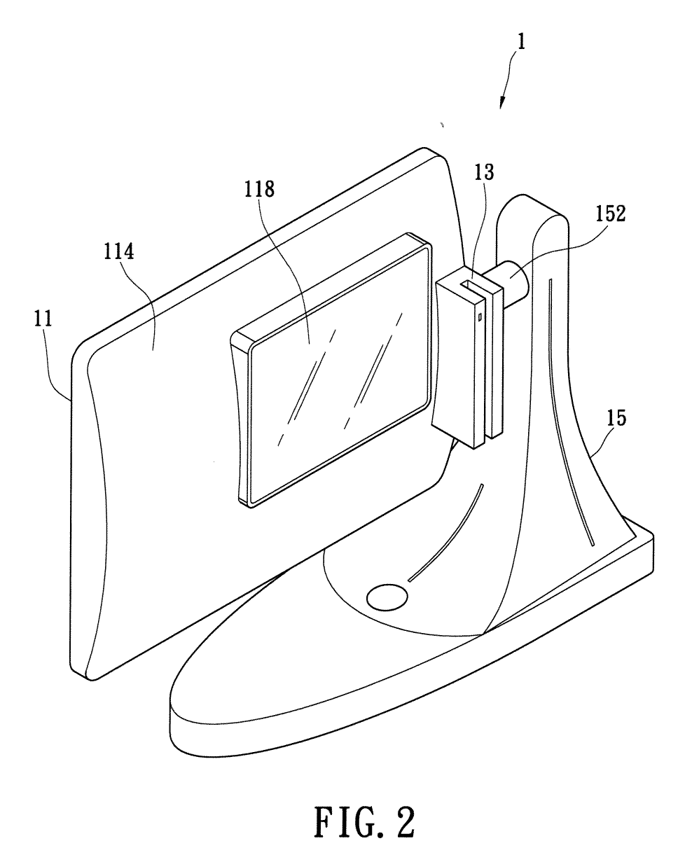

Referring to FIG. 1 and FIG. 2, which shows the first embodiment of the display device 1 of the instant disclosure. The display device 1 comprises a screen body 11 and two swipe card readers 13. The screen body 11 is usually a screen having a thin profile having a front surface 112 and a rear surface 114. The two swipe card readers 13 are disposed on the front surface 112 and the rear surface 114 separately. The swipe card readers 13 have different installation options on the display body 11, for example, vertically (U-shaped) installation and the laying horizontally (C-shaped) installation. The manufacturer may choose the better installation arrangement to suit the customers' particular requirements.

The screen body 11 further comprises at least one display screen unit. The at least one display screen unit may comprise a first display screen unit 116 and a second display screen unit 118 disposed on the front surface 112 and rear surface 114 separately, and electrically connected with the two swipe card readers 13. Therefore, the display device 1 has two display screen units on both two sides separately. In more detail, the display device 1 may further collaborate with the two swipe card readers 13 disposed on a front surface 112 and a rear surface 114. With this arrangement, somebody could swipes a card by the swipe card reader 13 on whether sides, and then, information may be displayed on the first display screen unit 116 and the second display screen unit 118 separately. Wherein, the information displayed on the first display screen unit 116 and the second display screen unit 118 may be individually controlled. Further, the at least one display screen unit may a first display screen unit 116, and optionally disposed the first display screen unit 116 on the front surface 112 or the rear surface 114 upon the surroundings.

Please referring to FIG. 1 and FIG. 2 again, the display device 1 further comprises a seat body 15, and the seat body 15 has a pivot 152. The screen body 11 pivotally connected to the seat body 15 by the pivot 152. Therefore, the screen body 11 may be rotationally adjusted to a desired vision fit user's eyesight.

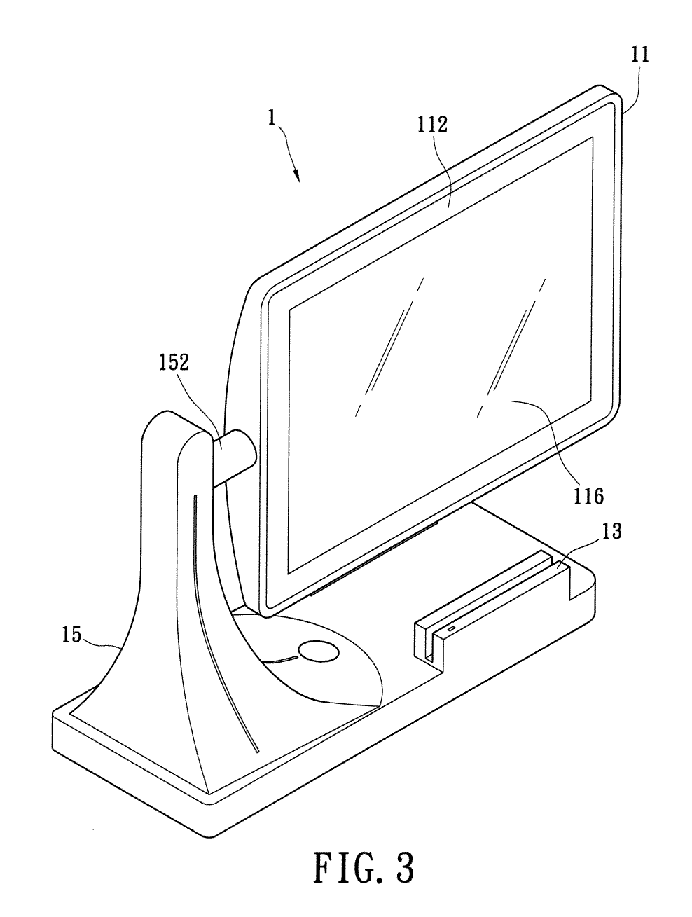

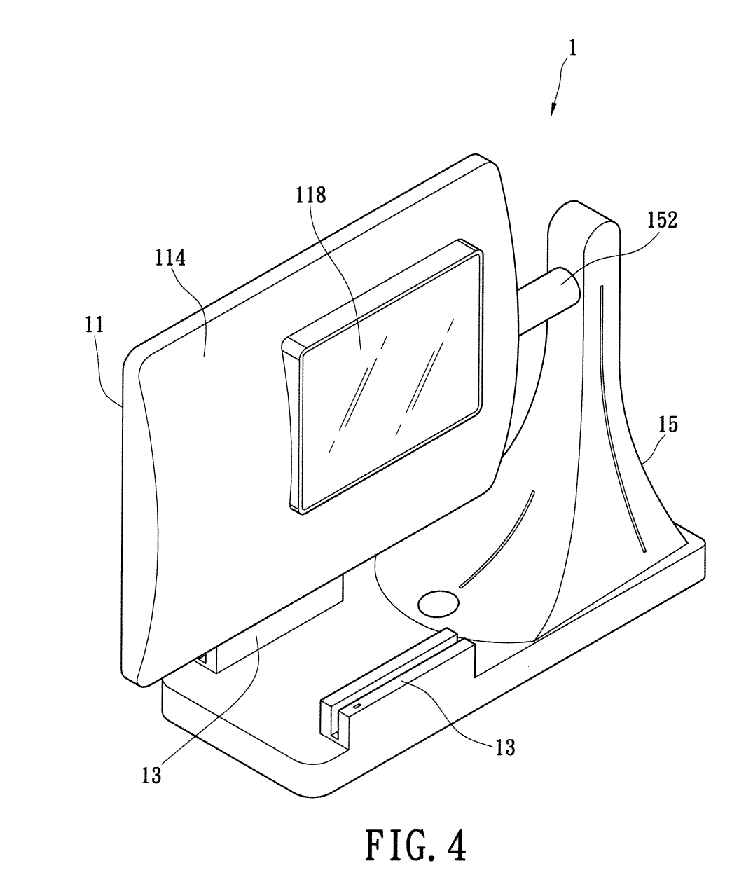

Referring to FIG. 3 to FIG. 4, which shows the second embodiment of the display device 1 of the instant disclosure. The display device 1 comprises a screen body 11, a seat body 15 and two swipe card readers 13. The screen body 11 comprises a front surface 112 and a rear surface 114 opposite to the front surface 112 and at least one display screen unit. The screen body 11 connects to the seat body 15. Two swipe card readers 13 are disposed on the opposite two sides along the normal direction of the front surface 112 and the rear surface 114. Therefore, users can conveniently swipe their cards by the swipe card reader 13 on the front surface 112 side or the rear surface 114 side. As the first embodiment, the swipe card reader 13 of the second embodiment has different installation options on the display body 11, for example, vertically (U-shaped) installation and the laying horizontally (C-shaped, not shown) installation. The manufacturer may choose the better installation style from the two installation ways upon the working surroundings. Wherein, there are still some difference with the first embodiment is that the swipe card reader 13 of the display device 1 is disposed on the seat body 15, and the swipe card reader 13 of the display device 1 of the second embodiment is disposed on the screen body 11. Other detailed structures are similar to the first embodiment, it is not described herein.

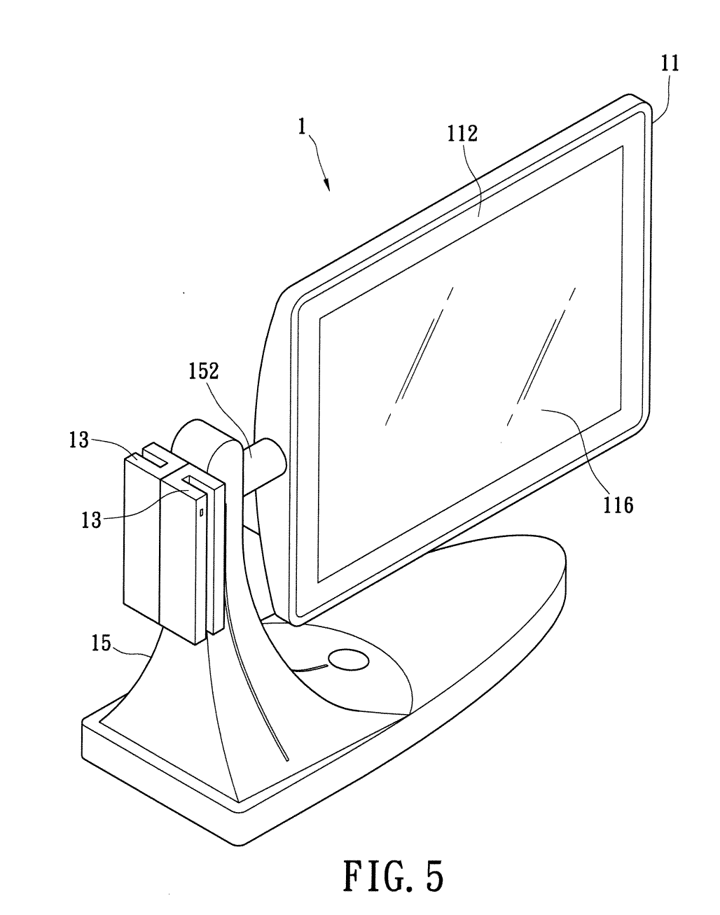

As shown in FIG. 5, is one of the variations of the position of the swipe card reader 13 of display device of the second embodiment. Two swipe card readers 13 are back to back aligned and connected to a lateral of the seat body 15 (or connected to a lateral of the display device 11, not shown). With this arrangement, a user can gain easy access to a card reader regardless which side he/she is on. All these equivalent modifications with two swipe card readers 13 still fall within scope of the claims of the present invention.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A display device, comprising:
a screen body having a front surface and a rear surface comprising at least one display screen unit; and
two swipe card readers separately disposed on the front surface and rear surface of the screen body and electrically connected to the at least one display screen unit.

2. The display device as claimed in claim 1, wherein the at least one display screen unit comprises a first display screen unit and a second display screen unit disposed on the front surface and the rear surface separately.

3. The display device as claimed in claim 2, further comprising a seat body having a pivot, wherein the screen body is pivotally connected to the seat body by the pivot.

4. The display device as claimed in claim 1, wherein the at least one display screen unit is disposed on the front surface or the rear surface of the screen body.

5. The display device as claimed in claim 4, further comprising a seat body having a pivot, wherein the screen body is pivotally connected to the seat body by the pivot.

6. A display device, comprising:
a screen body having a front surface and a rear surface comprising at least one display screen unit;
a seat body connected to the screen body having two opposite ends; and
two swipe card readers disposed on two opposite ends of the seat body along a normal direction of the front surface and the rear surface thereof and electrically connected to the display screen unit.

7. The display device as claimed in claim 6, wherein the at least one display screen unit comprises a first display screen unit and a second display screen unit separately disposed on the front surface and the rear surface of the screen body.

8. The display device as claimed in claim 7, wherein the seat body further has a pivot, and the screen body is pivotally connected to the seat body by the pivot.

9. The display device as claimed in claim 6, wherein the at least one display screen unit is disposed on the front surface or the rear surface.

10. The display device as claimed in claim 9, wherein the seat body further has a pivot, and the screen body is pivotally connected to the seat body by the pivot.
